(19) United States
(12) Patent Application Publication
(10) Pub. No.: US 2022/0188635 A1
(43) Pub. Date: Jun. 16, 2022

(54) System and Method For Detecting Misclassification Errors in Neural Networks Classifiers

(71) Applicant: Cognizant Technology Solutions U.S. Corporation, College Station, TX (US)

(72) Inventors: Xin Qiu, Changzhou City (CN); Risto Miikkulainen, Stanford, CA (US)

(73) Assignee: Cognizant Technology Solutions U.S. Corporation, College Station, TX (US)

(21) Appl. No.: 17/545,084

(22) Filed: Dec. 8, 2021

Related U.S. Application Data
(60) Provisional application No. 63/123,643, filed on Dec. 10, 2020.

(51) Int. Cl. G06N 3/08; G06N 3/04

(52) U.S. Cl. CPC G06N 3/08; G06N 3/0454

(57) ABSTRACT

An error detection framework, RED (Residual-based Error Detection), produces reliable confidence scores for detecting misclassification errors. RED calibrates the classifier's inherent confidence indicators and estimates uncertainty of the calibrated confidence scores using Gaussian Processes.

### CROSS REFERENCE TO RELATED APPLICATIONS

The present application claims benefit of and priority to U.S. Provisional Patent Application No. 63/123,643 entitled SYSTEM AND METHOD FOR DETECTING MISCLASSIFICATION ERRORS IN NEURAL NETWORKS CLASSIFIERS, which is incorporated herein by reference in its entirety.

Cross-reference is made to commonly-owned U.S. patent application Ser. No. 16/879,934 entitled QUANTIFYING THE PREDICTIVE UNCERTAINTY OF NEURAL NETWORKS VIA RESIDUAL ESTIMATE WITH I/O KERNEL, which is incorporated herein by reference in its entirety.

The following document is also incorporated herein by reference in its entirety: Xiu et al., Detecting Misclassification Errors in Neural Networks with a Gaussian Process Model, arXiv:2010.02065v3, May 2021.

Additionally, one skilled in the art appreciates the scope of the existing art which is assumed to be part of the present disclosure for purposes of supporting various concepts underlying the embodiments described herein. By way of particular example only, prior publications, including academic papers, patents and published patent applications listing one or more of the inventors herein are considered to be within the skill of the art and constitute supporting documentation for the embodiments discussed herein.

### BACKGROUND

### Field of the Embodiments

The subject matter described herein, in general, relates to neural network classifiers, and, in particular, relates to detecting misclassification errors in neural networks classifiers with reliable confidence scores.

### Description of Related Art

Classifiers based on Neural Networks (NNs) are widely deployed in many real-world applications. Although good prediction accuracies are achieved, lack of safety guarantees becomes a severe issue when NNs are applied to safety-critical domains, e.g., healthcare, finance, self-driving etc. One way to estimate trustworthiness of a classifier prediction is to use its inherent confidence-related score, e.g., the maximum class probability, entropy of the softmax outputs, or difference between the highest and second highest activation outputs. However, these scores are unreliable and may even be misleading as high-confidence but erroneous predictions are frequently observed. In a practical setting, it is beneficial to have a detector that can raise a red flag when-ever the predictions are likely to be wrong. A human observer can then evaluate such predictions, making the classification system safer.

In the past two decades, a large volume of work was devoted to calibrating the confidence scores returned by classifiers. Early works include Platt Scaling, histogram binning, isotonic regression, with recent extensions like Temperature Scaling, Dirichlet calibration, and distance-based learning from errors. These methods focus on reducing the difference between reported class probability and true accuracy, and generally the rankings of samples are preserved after calibration. As a result, the separability between correct and incorrect predictions is not improved.

A related direction of work is the development of classifiers with rejection/abstention option. These approaches either introduce new training pipelines/loss functions, or define mechanisms for learning rejection thresholds under certain risk levels. Designing metrics for detecting potential risks in NN classifiers has also become popular recently. While most approaches focus on detecting out-of-distribution (OOD) or adversarial examples, work on detecting natural errors, i.e., regular misclassifications not caused by external sources, is more limited.

In one prior approach, work in predicting whether a classifier is going to make mistakes was done, while others built a meta-grading classifier based on similar ideas. However, these early works did not consider NN classifiers. More recent works demonstrated raw maximum class probability as an effective baseline in error detection, although its performance was reduced in some scenarios.

In a practical setting, it is beneficial to have a detector that can raise a red flag whenever the predictions are suspicious. A human observer can then evaluate such predictions, making the classification system safer. In order to construct such a detector, quantitative metrics for measuring predictive reliability under different circumstances are first developed, and a warning threshold is then set based on users' preferred precision-recall tradeoff. Existing such methods can be categorized into three types based on their focus: error detection, which aims to detect the natural misclassifications made by the classifier; out-of-distribution (OOD) detection, which reports samples that are from different distributions compared to training data; and adversarial sample detection, which filters out samples from adversarial attacks.

Among these categories, error detection, also called misclassification detection, or failure prediction is the most challenging and underexplored. For instance, one of the attempts is defining a baseline based on maximum class probability after softmax layer. Although the baseline performs reasonably well in most testing cases, reduced efficacy in some scenario indicates room for improvement. More elaborate techniques for error detection have also been developed recently. One of the approaches proposed a confidence score based on the data embedding derived from the penultimate layer of a NN. However, their approach requires modifying the training procedure in order to achieve effective embeddings.

Another proposed solution provides for generating a Trust score, which measures the similarity between the original classifier and a modified nearest-neighbor classifier. The main limitation of this method is scalability of local distance computations: the Trust Score may provide no or negative improvement over the baseline for high-dimensional data. In another work, a separate NN model is built to learn the true class probability, i.e. softmax probability for the ground-truth class. Similarly one other approach utilizes the logit activations of the original NN classifier to predict its correctness. However, confidence levels of such standard NNs may be unreliable or misleading: a random input may generate a random confidence score, and no information is provided regarding uncertainty of these confidence scores.

Moreover, none of these methods can differentiate natural classifier errors from risks caused by OOD or adversarial samples, making it difficult to diagnose the sources of risks; if a detector could do that, it would be easier for practitioners to fix the problem, e.g., by retraining the original classifier or applying better preprocessing techniques to filter out OOD or adversarial data. In the background of foregoing limitations, there exists a need for error detection in NN classifiers that produce a calibrated confidence score with enhanced accuracy and reliability.

### SUMMARY OF THE EMBODIMENTS

In a first embodiment described herein, a process for detecting errors in a base neural network classifier includes: assigning a target detection score c to each training sample (χ,y) based on correctness of a classification prediction ŷ for the training sample by the base neural network classifier; predicting by a trained model with input-output (I/O) kernel, a residual r between the target detection score c and an original maximum class probability ĉ; and for a given data point x_{*}, providing a Gaussian distribution of estimated residual \hat{r}_{*}, wherein \hat{r}_{*} is defined by residual mean \hat{r̅}_{*} and variance var(\hat{r}_{*}); and adding \hat{r̅}_{*} and ĉ_{*} to calculate an error detection score ĉ′_{*}, wherein var(\hat{r}_{*}) indicates a corresponding uncertainty of the error detection score.

In a second embodiment described herein, at least one computer-readable medium storing instructions that, when executed by a computer, perform a process for detecting errors in a base neural network classifier which includes: assigning a target detection score c to each training sample (χ,y) based on correctness of a classification prediction ŷ for the training sample by the base neural network classifier; predicting by a trained model with input-output (I/O) kernel, a residual r between the target detection score c and an original maximum class probability ĉ; and for a given data point x_{*}, providing a Gaussian distribution of estimated residual \hat{r}_{*}, wherein \hat{r}_{*} is defined by residual mean \hat{r̅}_{*} and variance var(\hat{r}_{*}); and adding \hat{r̅}_{*} and ĉ_{*} to calculate an error detection score ĉ′_{*}, wherein var(\hat{r}_{*}) indicates a corresponding uncertainty of the error detection score.

In a third embodiment described herein, a dual model system for detecting errors in a base neural network classifier includes: a first model pre-trained as a base neural network classifier running on at least a first processor, wherein each training sample (χ,y) of the first model is assigned a target detection score c in accordance with correctness of the first model's classification prediction ŷ for the training sample; and a second trained model including input-output (I/O) kernel for predicting a residual r between the target detection score c and an original maximum class probability ĉ; wherein for a given data point x_{*}, the system provides a Gaussian distribution of estimated residual \hat{r}_{*}, wherein \hat{r}_{*} is defined by residual mean \hat{r̅}_{*} and variance var(\hat{r}_{*}), and calculates an error detection score ĉ′_{*} by adding \hat{r̅}_{*} and ĉ_{*}, and further wherein var(\hat{r}_{*}) indicates a corresponding uncertainty of the error detection score.

### BRIEF DESCRIPTION OF FIGURES

FIG. 1 depicts an error detection framework training and deployment process, in accordance with a preferred embodiment of the present disclosure;

FIG. 2 illustrates exemplary performance ranks for different error detection frameworks in accordance with a preferred embodiment of the present disclosure;

FIG. 3 shows the results of the two error detection performance metrics for different error detection frameworks in accordance with a preferred embodiment of the present disclosure; and

FIGS. 4a, 4b, 4c show distribution of mean and variance of detection scores for a preferred error detection framework across different testing samples.

### DETAILED DESCRIPTION OF THE EMBODIMENTS

In describing the preferred and alternate embodiments of the present disclosure, specific terminology is employed for the sake of clarity. The disclosure, however, is not intended to be limited to the specific terminology so selected, and it is to be understood that each specific element includes all technical equivalents that operate in a similar manner to accomplish similar functions. The disclosed embodiments are merely exemplary methods of the invention, which may be embodied in various forms.

Generally, the embodiments herein describe a framework that meets the challenges identified in the description of the prior art and produces reliable confidence scores for detecting misclassification errors in neural network (NN) classifiers. Precisely, the framework, referred to as Residual-based Error Detection (RED), where RIO (R for residual, and IO for the input-output kernel) makes it possible to estimate uncertainty in any pre-trained standard NN. The RIO process is described in co-owned U.S. patent application Ser. No. 16/879,934 entitled Quantifying the Predictive Uncertainty of Neural Networks via Residual Estimate with I/O Kernel, which is incorporated herein by reference in its entirety. This framework, RED, calibrates the classifier's inherent confidence indicators and estimates uncertainty of the calibrated confidence scores using Gaussian Processes (GP). Accordingly, GP based RIO, i.e., RED, is utilized on top of original NN classifier. The framework not only produces a calibrated confidence score based on original maximum class probability, but also provides a quantitative uncertainty estimation of that score. The reliability of error detection is therefore enhanced.

In accordance with one working embodiment, the RED framework is compared empirically to existing approaches on 125 UCI datasets and on a large-scale deep learning architecture. The results demonstrate that the approach is effective and robust, as the scores derived can better differentiate incorrect predictions from correct ones. Further, in contrast to existing approaches, RED assumes an existing pre-trained NN classifier, and provides an additional metric for detecting potential errors made by this classifier, without specifying a rejection threshold.

In accordance with one general embodiment of present disclosure, a basic understanding of original RIO (R for residual, and IO for the input-output kernel), on which RED is built, is introduced. Now, consider a training dataset [symbol] =(χ,y)={(xᵢ,yᵢ)}ᵢ₌₁^{N}, and a pre-trained NN classifier that outputs a predicted label ŷᵢ and class probabilities for each class σᵢ=[\hat{p}_{i,1}, \hat{p}_{1,2}, . . . , \hat{p}_{i,K}] given xᵢ, where N is the total number of training points and K is the total number of classes. The problem is to develop a metric that can serve as a quantitative indicator for detecting natural misclassification errors made by the pre-trained NN classifier.

To begin with, RIO is developed to quantify point-prediction uncertainty in regression models. More specifically, RIO fits a GP to predict the residuals, i.e. the differences between ground-truth and original model predictions. It utilizes an I/O kernel, i.e. a composite of an input kernel and an output kernel, thus taking into account both inputs and outputs of the original regression model. As a result, it measures the covariance between data points in both the original feature space and the original model output space. For each new data point, a trained RIO model takes the original input and output of the base regression model, and predicts a distribution of the residual, which can be added back to the original model prediction to obtain both a calibrated prediction and the corresponding predictive uncertainty.

In the original RIO work, SVGP (Hensman et al., Gaussian Processes for Big Data, Proceedings of the Twenty-Ninth Conference on Uncertainty in Artificial Intelligence, UAI'13, 282-290 (2013); Hensman et al., Scalable Variational Gaussian Process Classification. In Lebanon, G.; and Vishwanathan, S. V. N., eds., Proceedings of the Eighteenth International Conference on Artificial Intelligence and Statistics, volume 38 of Proceedings of Machine Learning Research, 351-360 (2015)) was used as an approximate GP to improve the scalability of the approach. Both empirical results and theoretical analysis showed that RIO is able to consistently improve the prediction accuracy of the base model as well as provide reliable uncertainty estimation. Moreover, RIO can be directly applied on top of any pre-trained models without retraining or modification. It therefore forms a promising foundation for improving reliability of error detection metrics as well.

Although RIO performs robustly in a wide variety of regression problems, it cannot be directly applied to classification models. A new framework, RED, is proposed to utilize RIO for error detection in classification domains. Building on the fact that the original maximum class probability is a strong baseline for error detection, the main idea of RED is to derive a more reliable confidence score by stacking RIO on top of the original maximum class probability. Since RIO was designed for single-output regression problems, it contains an output kernel only for scalar outputs. In RED, this original output kernel is extended to multiple outputs, i.e. to vector outputs such as those of the final softmax layer of a NN classifier, representing estimated class probabilities for each class. This modification allows RIO to access more information from the classifier outputs. This new variant of RIO is hereinafter referred to as mRIO (“m” for multi-output).

To utilize RIO in the classification domain, the targets for RIO training need to be redesigned as well. The raw targets of a classification problem are the ground-truth labels; they are in categorical space, while RIO works in continuous space. To solve this issue, RED constructs a different problem: Instead of predicting the labels directly, RED learns to predict whether the original prediction is correct or not. A target detection score is assigned to each training data point according to whether it is correctly classified by the base model. The residual between this target score and the original maximum class probability is calculated, and an mRIO model is trained to predict these residuals. Given a new data point, the trained mRIO model combined with the original base NN classifier thus provides an aggregated score for detecting misclassification errors. In this process, the outputs of the base classifiers are not changed.

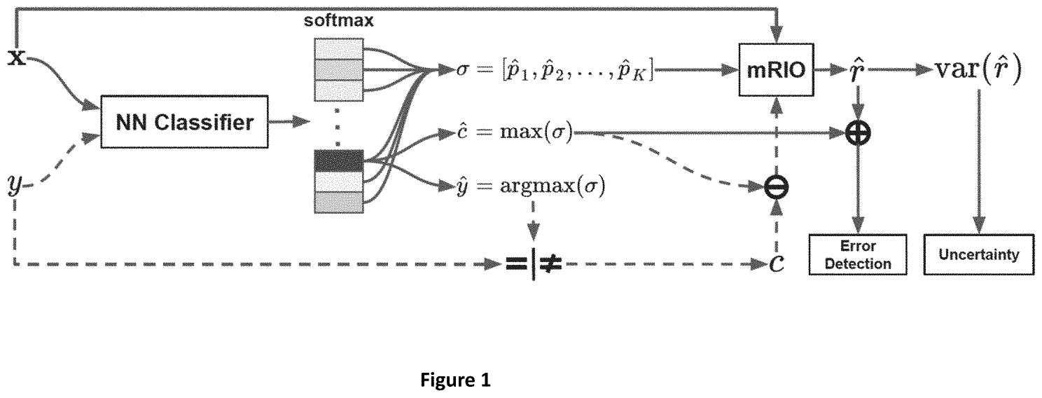

FIG. 1 is a schematic illustrating the conceptual RED training and deployment process. The solid line pathways shown are active in both the training and deployment phase, while the dashed pathways are active only in the training phase. During the training phase, a target detection score c is assigned to each training sample according to whether it is correctly predicted by the original NN classifier or not. An mRIO model is then trained to predict the residual between the target detection score c and the original maximum class probability ĉ. The I/O kernel in mRIO utilizes both the raw feature x and softmax outputs σ to predict the residuals. In the deployment phase, given a new data point, the trained mRIO model provides a Gaussian distribution of estimated residual \hat{r} defined by the mean \hat{r̅} and variance var(\hat{r}). Addition of \hat{r} and ĉ forms a score for error detection, and var(\hat{r}) indicates the corresponding uncertainty.

Algorithm 1 set forth below provides a more detailed description of the processes illustrated in FIG. 1.

Algorithm 1: RED training and deployment procedures

```
Require:
    ( [symbol] , y) = {(xᵢ, yᵢ)}ᵢ₌₁^{N}: training data
    ŷ = {ŷᵢ}ᵢ₌₁^{N}: labels predicted by original NN classifier on training data
    σ = {σᵢ = [\hat{p}_{i,1}, \hat{p}_{i,2}, . . . , \hat{p}_{i,K}]}ᵢ₌₁^{N}: softmax outputs of original NN classifier
    on training data
    ĉ ={ĉᵢ = max(σᵢ)}ᵢ₌₁^{N}: maximum class probability returned by original NN
    classifier on training data
    x_{*}: data to be predicted
    σ_{*}: softmax outputs of original NN classifier on x_{*}
    ĉ_{*}: maximum class probability returned by original NN classifier on x_{*}
Ensure:
    ĉ_{*}′~ [symbol]   (ĉ_{*} +\overline{\hat{r}}_{*}, var(\hat{r}_{*})): ĉ_{*} +\overline{\hat{r}}_{*} can be used as detection score for error
    detection, and var(\hat{r}_{*}) represents the uncertainty of returned detection score
Training Phase:
  1. obtain target detection score c = {cᵢ = δ_{y}_{ᵢ}_{,}\hat{_{y}}_{ᵢ}}ᵢ₌₁^{N} , where δ_{y}_{ᵢ}_{,}\hat{_{y}}_{ᵢ} is the Kronecker delta
    (δ_{y}_{ᵢ}_{,}\hat{_{y}}_{ᵢ} = 1 if yᵢ = ŷᵢ, otherwise δ_{y}_{ᵢ}_{,}\hat{_{y}}_{ᵢ} = 0)
  2. calculate residuals r ={rᵢ = cᵢ −ĉᵢ}ᵢ₌₁^{N}
  3. for each optimizer step do
  4. calculate covariance matrix K_{c}(( [symbol] , σ), ( [symbol] , σ)), where each entry is given by
    k_{c}((xᵢ, σᵢ), (xⱼ, σⱼ)) = kᵢₙ (xᵢ, xⱼ) + kₒᵤₜ (σᵢ, σⱼ), for i, j =1,2, . . . , N
  5. optimize GP hyperparameters by maximizing log marginal likelihood logp(r| [symbol] , σ) =
    $- \frac{1}{2} {{r}^{T} ( {K}_{c} ( ( , σ ) , ( , σ ) ) + {σ}_{n}^{2} I )}^{- 1} r - \frac{1}{2} log \vert {K}_{c} ( ( , σ ) , ( , σ ) ) + {σ}_{n}^{2} I \vert - \frac{n}{2} log 2 π$
Deployment Phase:
  6. calculate residual mean \overline{\hat{r}}_{*} = k_{*}^{T} (K_{c}(( [symbol] , σ), ( [symbol] , σ)) + σₙ²I)⁻¹r and residual variance
    var(\hat{r}_{*}) = kc((x_{*},σ_{*}), (x_{*}, σ_{*} )) − k_{*}^{T}(K_{c} (( [symbol] , σ), ( [symbol] , σ)) + σₙ²I)⁻¹k_{*}, where k_{*} denotes
    the vector of kernel-based covariances (i.e., k_{c} (x_{*}, xᵢ)) between x_{*} and all training data
  7. return distribution of error detection score ĉ_{*}^{′}~ [symbol]  (ĉ_{*} + \overline{\hat{r}}_{*}, var(\hat{r}_{*}))
```

In the training phase, the first step is to define a target detection score cᵢ for each training sample (xᵢ, yᵢ, ŷᵢ, σᵢ). In nature, any functions that assign target values to correct and incorrect predictions differently can be used. For simplicity, the Kronecker delta δyᵢ,ŷᵢ is used in this work: all training samples that are correctly predicted by the original NN classifier receive 1 as the target detection score, and those that are incorrectly predicted receive 0. The validation dataset during the original NN training is included in the training dataset for RED. After the target detection scores are assigned, a regression problem is formulated for the mRIO model: Given the original raw features {xᵢ}ᵢ₌₁^{N} and the corresponding softmax outputs of the original NN classifier {σᵢ=[\hat{p}_{i,1}, \hat{p}_{i,2}, . . . , \hat{p}_{i,K}]}ᵢ₌₁^{N}, predict the residuals r={rᵢ=cᵢ−ĉᵢ}ᵢ₌₁ⁿ between target detection scores c={cᵢ}ᵢ₌₁^{N} and the original maximum class probabilities ĉ={ĉᵢ=max(σᵢ)}ᵢ₌₁^{N}.

The mRIO model relies on an I/O kernel consisting of two components: the input kernel kᵢₙ(xᵢ,xⱼ), which measures covariances in the raw feature space, and the modified multi-output kernel kₒᵤₜ(σᵢ,σⱼ), which calculates covariances in the softmax output space. The hyperparameters of the I/O kernel are optimized to maximize the log marginal likelihood log p(r|χ,σ). In the deployment phase, given a new data point x_{*}, the trained mRIO model provides a Gaussian distribution for the estimated residual \hat{r}_{*}˜ [symbol] (\hat{r̅}_{*}, var(\hat{r}_{*})). By adding the estimated residual back to the original maximum class probability ĉ_{*}, a distribution of detection score is obtained as ĉ′_{*}˜ [symbol] (ĉ_{*}+\hat{r̅}_{*}, var(\hat{r}_{*})). The mean ĉ_{*}+\hat{r̅}_{*} can be directly used as a quantitative metric for error detection, and the variance var(\hat{r}_{*}) represents the corresponding uncertainty of the detection score.

In one working embodiment, the error detection performance of RED is evaluated comprehensively on 125 UCI datasets, comparing it to other related methods. As discussed further herein, RED's generality is evaluated by applying it to two other base models, and its scale-up properties are measured in two larger deep learning architectures solving two vision tasks. Further, RED's potential to improve robustness more broadly is demonstrated in a study involving OOD and adversarial samples.

As a comprehensive evaluation of RED, an empirical comparison with seven existing approaches on 125 UCI datasets is performed. All features in all datasets are normalized to have mean 0 and standard deviation 1. The reference approaches include: maximum class probability (MCP) baseline, Trust Score, ConfidNet, and Introspection-Net, as well as entropy of the original softmax outputs and the original SVGP.

Ten independent runs are conducted for each dataset. During each run, the dataset is randomly split into training dataset and testing dataset, and a standard NN classifier trained and evaluated on them. The same dataset split and trained NN classifier is used to evaluate all methods. In a specific exemplary experimental setup, the dataset is randomly split into a training set (80%) and a testing set (20%), then a fully connected feed-forward NN classifier with 2 hidden layers, each with 64 hidden neurons, are trained on the training set. The activation function is ReLU for all the hidden layers. The maximum number of epochs for training is 1000. 20% of the training set is used as validation set, and the split is random at each independent run. An early stop is triggered if the loss on validation set has not been improved for 10 epochs. The optimizer is Adam with learning rate 0.001, β₁=0.9, and β₂=0.999. The loss function is cross entropy loss. During each independent run, the same random dataset split and trained base NN classifier is used for evaluating all algorithms. Results on some datasets are not included in the summary tables set forth herein if the base classifier does not make any misclassifications, or the number of samples in one particular class is too small for Trust Score to calculate neighborhood distance, or a numerical instability issue happens during the training of the BLR-residual. The experiments run on a machine with 20 Intel(R) Xeon(R) Gold 5215 CPU @ 2.50 GHz, 128 GB memory, and a GTX 2080. One skilled in the art will readily recognize changes and/or addition to the present experimental set-up which may be implemented, but do not substantively change the embodied concepts.

In the empirical comparison, the following parametric setups were used. For RED, SVGP is used as an approximator to original GP. The number of inducing points is 50. RBF kernel is used for both input and multi-output kernel. Automatic Relevance Determination (ARD) feature is turned on. The signal variances and length scales of all the kernels plus the noise variance are the trainable hyperparameters. The optimizer is L-BFGS-B with default parameters as in Scipy.optimize documentation (which is publicly available) and the maximum number of iterations is set as 1000. The optimization process runs until the L-BFGS-B optimizer decides to stop. To overcome the sensitivity of GP optimization to initialization of the hyperparameters, 20 random initialization of the hyperparameters are tried for each independent run. For each random initialization, the signal variances are generated from a uniform distribution within interval [0, 1], and the length scales are generated from a uniform distribution within interval [0, 10]. For 10 initializations, the hyperparameters of input kernel are first optimized while the multi-output kernel is temporarily turned off, then after the optimizer stops, the multi-output kernel is turned on, and both the two kernels are optimized simultaneously. For the other 10 initializations, both kernels are optimized simultaneously from the start. The average performance of the 3 best optimized model in terms of corresponding metrics are used as the final performance of RED on each independent run. During our preliminary investigation, several statistic metrics on training set is effective in picking the true best-performing model out of these 20 trials, e.g., the gap between average estimated detection scores of correctly classified training samples and incorrectly classified training samples, the scale of optimized noise variance of SVGP model, the ratio between sum of signal variances and noise variance after optimization, etc. Since improving initialization and optimization of GP hyperparameters is not the focus of the embodiments herein, average performance of the best 3 models (top 15%) is used in the comparison.

For MCP baseline, the maximum class probability of softmax outputs of the base NN classifier is used as the detection score of MCP baseline. The setup of the base NN classifier is discussed above.

For Trust Score, k=10, α=0, without filtering. This is the same as the default setup which is publicly available.

For ConfidNet, during training, the input to ConfidNet is the raw feature, and the target is the class probability of the ground-truth class returned by base NN classifier. The architecture of ConfidNet is a fully connected feed-forward NN regressor with 2 hidden layers, each with 64 hidden neurons. The activation function is ReLU for all the hidden layers. The maximum number of epochs for training is 1000. An early stop is triggered if the loss on validation data has not been improved for 10 epochs. The optimizer is RMSprop with learning rate 0.001, and the loss function is mean squared error (MSE).

For Introspection-Net, during training, the input to Introspection-Net is the logit outputs of base NN classifier, and the target is 1 for correctly classified sample, and 0 for incorrectly classified sample. The architecture of ConfidNet is a fully connected feed-forward NN regressor with 2 hidden layers, each with 64 hidden neurons. The activation function is ReLU for all the hidden layers. The maximum number of epochs for training is 1000. An early stop is triggered if the loss on validation data has not been improved for 10 epochs. The optimizer is RMSprop with learning rate 0.001, and the loss function is mean squared error (MSE).

For Entropy, the entropy of softmax outputs of the base NN classifier is used as the detection score of Entropy. The setup of the base NN classifier is provided above.

For DNGO, a Bayesian linear regression layer similar to that described in Snoek et al., Scalable Bayesian optimization using deep neural networks, Proceedings of the 32nd International Conference on Machine Learning—Volume 37, ICML'15, pp. 2171-2180. JMLR.org (2015), is added after the logits layer of the original NN classifier to predict whether an original prediction is correct or not (1 for correct and 0 for incorrect). Default parametric setup, as is known to those skilled in the art is used.

For SVGP, the original SVGP without output kernel is used to predict directly whether a prediction made by the base NN classifier is correct or not (1 for correct and 0 for incorrect). All other parameters are identical to those in RED described above.

For BNN MCP, the standard dense layers in the base NN classifier described in RED setup above is replaced with Flipout layers. All other parameters are identical with those in RED described above. The maximum class probability averaging over 100 test-time samplings is used as the detection score for error detection.

For BNN Entropy, the same setup as with BNN MCP, except now the entropy of softmax outputs averaging over 100 test-time samplings is used as the detection score for error detection.

For MC-Dropout MCP, a dropout layer with dropout rate of 0.5 is added after each dense layer of the base NN classifier described in the RED setup. All other parameters are identical with those in RED described above. The maximum class probability averaging over 100 test-time Monte-Carlo samplings is used as the detection score for error detection.

For MC-Dropout Entropy, the same setup as with MC-Dropout MCP, except now the entropy of softmax outputs is averaged over 100 test-time Monte-Carlo samplings and used as detection score for error detection.

For BLR-residual, the GP model in original RED is replaced by a Bayesian linear regression (BLR) similar to that of Snoek et al. (2015) referenced above. The BLR is trained to predict the \hat{r̅}_{*} and var(\hat{r}_{*}), and the remaining components in the framework are exactly the same as in the original RED described above. A default parametric set-up for BLR is publicly available and known to those skilled in the art.

Following the experimental setup described above, the task for each algorithm is to provide a detection score for each testing point. An error detector can then use a predefined fixed threshold on this score to decide which points are probably misclassified by the original NN classifier. For RED, the mean of calibrated confidence score ĉ_{*}+\hat{r̅}_{*} is used as the reported detection score.

In one working embodiment, five threshold-independent performance metrics are used to compare the methods: AUPR-Error, which computes the area under the Precision-Recall (AUPR) Curve when treating incorrect predictions as positive class during the detection; AUPR-Success, which is similar to AUPR-Error but uses correct predictions as positive class; AUROC, which computes the area under receiver operating characteristic (ROC) curve for the error detection task; AP-Error, which computes the average precision (AP) under different thresholds treating incorrect predictions as positive class; and AP-Success, which is similar to AP-Error but uses correct predictions as positive class. AUPR may provide overly-optimistic measurement of performance. To compensate for this issue, AP-Error and AP-Success are included as additional metrics. Since the target for the confidence metrics is to detect misclassification errors, the following discussion will focus more on AP-Error and AUPR-Error.

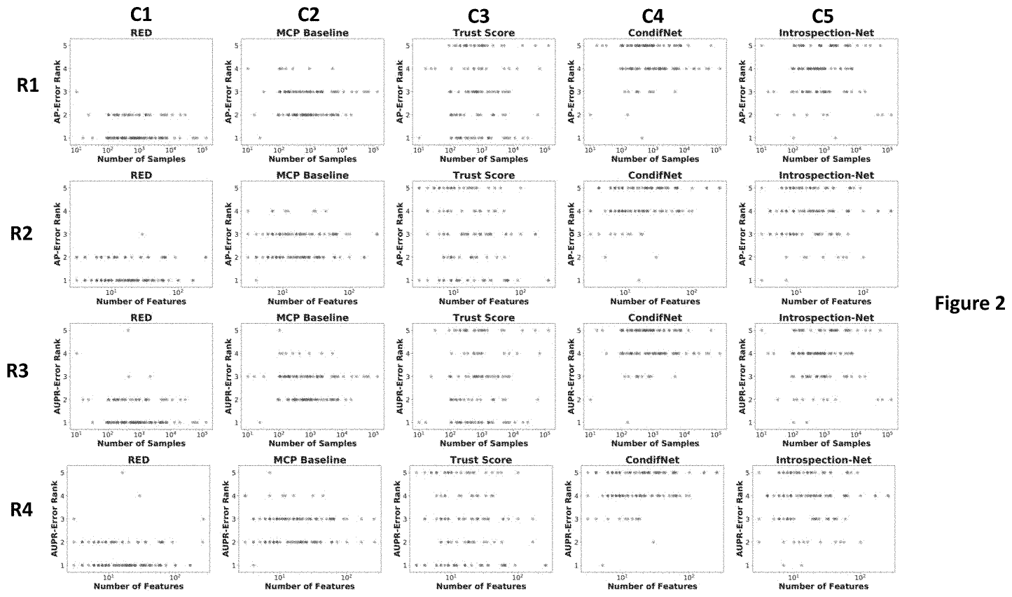

FIG. 2 includes exemplary performance ranks for RED, MCP Baseline, Trust Score, ConfidNet and Instrospection-Net across dataset sizes and feature dimensionalities on the 125 UCI datasets. Each plot represents the distribution of relative ranks for one algorithm (i.e., method) (each column C1, C2, C3, C4, C5 includes plots for different algorithms) as a function of the dataset size (R1 and R3) and the feature dimensionality (R2 and R4). Rows R1 and R2 use AP-Error Rank and rows R3 and R4 use AUPR-Error Rank. Each dot in each plot represents the relative rank in one dataset. The plots reveal that RED performs consistently well over datasets of different sizes and feature dimensionalities, while Trust Score performs inconsistently, and ConfidNet performs poorly on larger datasets.

Table 1 below shows the ranks of each of the eight algorithms, RED plus the seven comparison algorithms, averaged over all 125 UCI datasets. The rank of each algorithm on each dataset is based on the average performance over the 10 independent runs. RED performs best on all metrics; the performance differences between RED and all other methods are statistically significant under paired t-test and Wilcoxon test. Trust Score has the highest standard deviation, suggesting that its performance varies significantly across different datasets.

TABLE 1

| | AP-Error | AUPR-Error | AP-Success | AUPR-Success | AUROC |
|---|---|---|---|---|---|
| Method | mean ± std | mean ± std | mean ± std | mean ± std | mean ± std |
| RED | 1.39 ± 0.61* | 1.49 ± 0.78* | 1.74± 0.97* | 1.80 ± 1.03* | 1.65 ± 0.82* |
| MCP | 2.93 ± 0.89 | 3.06 ± 0.92 | 2.77 ± 1.07 | 2.75 ± 1.11 | 2.80 ± 1.08 |
| T-Score | 3.92 ± 2.45 | 3.86 ± 2.50 | 3.64 ± 2.25 | 3.61 ± 2.25 | 3.76 ± 2.31 |
| C-Net | 6.13 ± 1.37 | 6.33 ± 1.38 | 3.07 ± 1.51 | 6.07 ± 1.41 | 5.97 ± 1.45 |
| I-Net | 5.34 ± 1.65 | 5.38 ± 1.65 | 5.83 ± 1.46 | 5.89 ± 1.51 | 5.71 ± 1.50 |
| Entropy | 3.47 ± 1.08 | 3.59 ± 1.19 | 3.19 ± 1.26 | 3.23 ± 1.32 | 3.26 ± 1.28 |
| DNGO | 6.19 ± 1.51 | 5.46 ± 1.82 | 6.84 ± 1.33 | 6.80 ± 1.44 | 6.57 ± 1.47 |
| SVGP | 6.59 ± 1.60 | 6.80 ± 1.49 | 5.89 ± 1.54 | 5.83 ± 1.49 | 6.24 ± 1.61 |

As a more detailed comparison, Table 2 shows how often RED performs statistically significantly better, how often the performance is not significantly different, and how often it performs significantly worse than the other methods. Specifically, for each of the five error metrics, the columns labeled (+) show the number of datasets on which RED performs significantly better at the 5% significance level in a paired t-test, Wilcoxon test, or both; columns labeled (−) represent the contrary case; and columns labeled (=) represent no statistical significance.

TABLE 2

| RED | AP-Error | AUPR-Error | AP-Success | AUPR-Success | AUROC |
|---|---|---|---|---|---|
| vs. | +/=/− | +/=/− | +/=/− | +/=/− | +/=/− |
| MCP | 87/35/0 | 90/32/0 | 58/63/1 | 56/65/1 | 61/60/1 |
| T-Score | 53/44/16 | 49/47/17 | 50/47/16 | 48/49/16 | 59/37/17 |
| C-Net | 100/22/0 | 100/22/0 | 106/16/0 | 106/16/0 | 109/13/0 |
| I-Net. | 93/29/0 | 90/32/0 | 98/24/0 | 98/24/0 | 101/21/0 |
| Entropy | 74/47/1 | 75/46/1 | 53/68/1 | 53/68/1 | 52/69/1 |
| DNGO | 92/17/0 | 73/31/5 | 99/10/0 | 97/12/0 | 98/11/0 |
| SVGP | 98/23/1 | 98/23/1 | 97/25/0 | 97/25/0 | 102/19/1 |
| BNN-M | 102/20/0 | 104/18/0 | 95/26/1 | 88/33/1 | 95/26/1 |
| BNN-E | 67/53/2 | 68/52/2 | 48/66/8 | 48/66/8 | 53/64/5 |
| MCD-M | 87/35/0 | 88/34/0 | 70/52/0 | 67/55/0 | 71/51/0 |
| MCD-E | 54/68/0 | 55/67/0 | 38/77/7 | 38/76/8 | 42/74/6 |
| BLR-res | 77/43/0 | 76/44/0 | 92/28/0 | 90/30/0 | 88/32/0 |

As is clear from Table 2, RED is most often significantly better, and very rarely worse. In a handful of datasets Trust Score is better, but most often it is not. RED performs consistently well over different dataset sizes and feature dimensionalities. Trust Score performs best in several datasets, but occasionally also worst in both small and large datasets, making it a rather unreliable choice. ConfidNet generally exhibits worse performance on datasets with large dataset sizes and high feature dimensionalities, i.e. it does not scale well to larger problems.

To evaluate whether GP is indeed an appropriate model for the RED framework, it was replaced by a Bayesian linear regressor, with all other components unchanged. This BLR-residual (BLR-res) variant was then compared with the original RED in all 125 UCI datasets. Results in Table 2 (last row) show that RED dominates BLR-res, indicating that GP is a good choice for error detection tasks.

To evaluate generality of RED, it was applied to two other base models: an NN classifier using Monte Carlo-dropout (MCD) technique and a Bayesian Neural Network (BNN) classifier. They were each trained as base classifiers, and RED was then applied to each of them. Experiments analogous to those described above were performed on 125 UCI datasets in both cases. Table 2 (rows starting with “BNN” or “MCD”) summarizes the pairwise comparisons between RED and the internal detection scores returned by the base models. “-M” and “-E” represent the maximum class probability and entropy of softmax outputs, respectively, after averaging over 100 test-time samplings. RED significantly improves MCD and BNN classifier in most datasets, demonstrating that it is a general technique that can be applied to a variety of models.

To confirm that the RED approach scales up to large deep learning architectures, a VGG16 model was trained on the CIFAR-10 dataset, and a VGG19 model was trained on the CIFAR-100 dataset, both using state-of-the-art training pipelines as is known to those skilled in the art. For the CIFAR-10/CIFAR-100 datasets, 40,000 samples are used as the training set, 10,000 as the validation set, and 10,000 as the testing set. In order to remove the influence of feature extraction in image preprocessing and to make the comparison fair, all approaches used the same logit outputs of the trained VGG16/VGG19 model as their input features. The maximum class probability of softmax outputs of the trained VGG16/VGG19 model is used as the detection score of MCP baseline. The parameters for RED, Trust Score, Entropy, DNGO and SVGP are identical to those in the UCI experiments. For ConfidNet and Introspection-Net, all parameters are the same as in the UCI experiments, except for that the number of hidden neurons for all hidden layers is increased to 128. 10 independent runs are performed. During each run, a VGG16/VGG19 model is trained, and all the methods are evaluated based on this VGG16/VGG19 model.

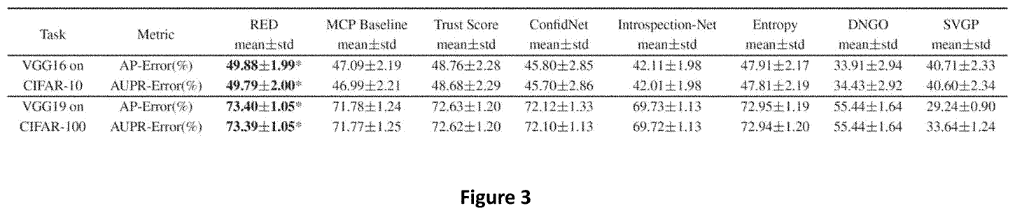

FIG. 3 shows the results on the two main error detection performance metrics (note that the table lists absolute values instead of rankings along each metric). Trust Score performs much better than in previous literatures. This difference may be due to the fact that logit outputs are used as input features here, whereas the prior art utilized a higher dimensional feature space for Trust Score. RED significantly outperforms all the counterparts in both metrics. This result demonstrates the advantages of RED in scaling up to larger architectures.

In all experiments so far, the mean of calibrated confidence score ĉ_{*}+\hat{r̅}_{*} is used as RED's confidence score. Although good performance is observed in error detection by only using the mean, the variance of calibrated confidence score var(\hat{r}_{*}) may be helpful if the scenario is more complex, e.g., the dataset includes some OOD data, or even adversarial data.

RED was evaluated in such a scenario by manually adding OOD and adversarial data into the test set of all 125 UCI datasets. The synthetic OOD and adversarial samples were created to be highly deceptive, aiming to evaluate the performance of RED under difficult circumstances. The OOD data were sampled from a Gaussian distribution with mean 0 and variance 1. All samples from original dataset were normalized to have mean 0 and variance 1 for each feature dimension so that the OOD data and in-distribution data had similar scales. The adversarial data simulate situations where negligible modifications to training samples cause the original NN classifier to predict incorrectly with highest confidence.

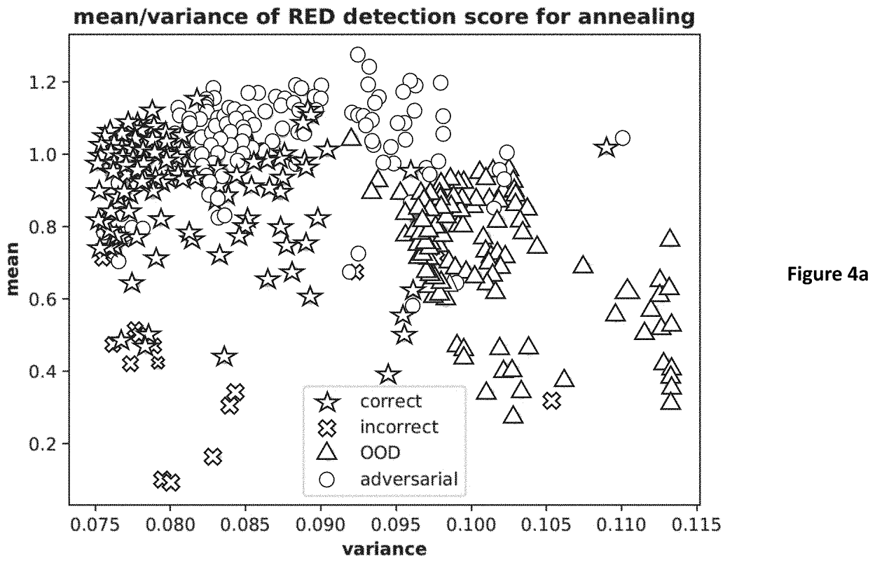

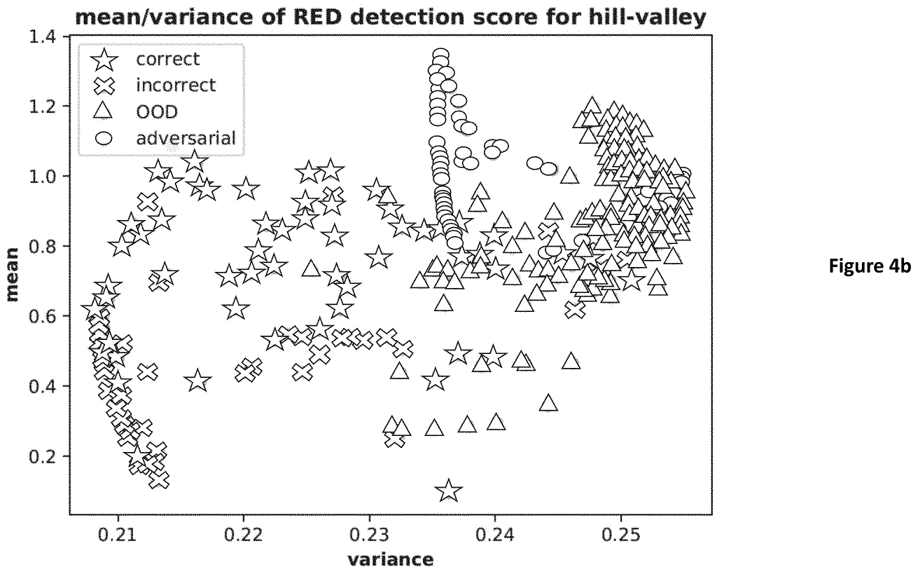

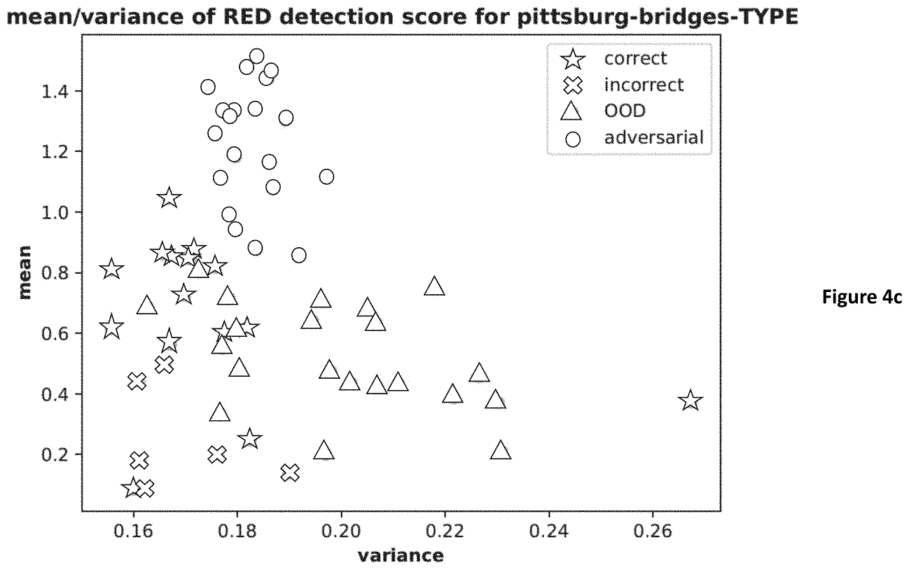

FIGS. 4a, 4b, 4c show the distribution of mean and variance of detection scores for testing samples, including correctly and incorrectly labeled actual samples, as well as the synthetic OOD and adversarial samples. Each of the four shapes represents one sample in the testing set in the corresponding UCI task. The horizontal axis denotes the variance of RED-returned detection score, and the vertical axis denotes the mean. If an in-distribution sample is correctly classified by original NN classifier, it is marked as “correct”, otherwise it is marked “incorrect”. Mean is a good separator of correct and incorrect classifications. High variance, on the other hand, indicates that RED is uncertain about its detection score, which can be used to identify OOD and adversarial samples. RED's detection scores of in-distribution samples have low variance because they covary with the training samples. The variance thus represents RED's confidence in its detection score. Samples with large variance indicate that RED is uncertain about its detection score, which can be used as a basis for detecting OOD and adversarial samples.

In order to quantify the potential of RED in detecting OOD and adversarial samples, the variance of detection scores var(\hat{r}_{*}) (RED-variance) was used as the detection metric, and detection performance compared with MCP baseline and stardard RED (RED-mean) in all 125 UCI datasets (10 independent runs each). The performance in detecting OOD samples was measured by AP-OOD and AUPR-OOD, which treat OOD samples as the positive class. Similarly, AP-Adversarial and AUPR-Adversarial were used as measures in detecting adversarial samples. The RED training pipeline was exactly the same as described herein above. A summary of the experimental results is shown in Table 3.

TABLE 3

| RED-variance | AP-OOD | AUPR-OOD | AP-Adversarial | AUPR-Adversarial |
|---|---|---|---|---|
| vs. | +/=/− | +/=/− | +/=/− | +/=/− |
| MCP baseline | 101/15/9 | 101/13/11 | 122/3/0 | 124/1/0 |
| RED-mean | 100/14/11 | 100/13/12 | 122/3/0 | 122/3/0 |

RED-variance performs well in both OOD and adversarial sample detection even though it was not trained on any OOD/adversarial samples. In contrast, the original MCP baseline performs significantly worse in both scenarios. The original NN classifier always returns highest class probabilities on deceptive adversarial samples; as a result, MCP makes a purely random guess, resulting in a consistent AP-Adversarial/AUPR-Adversarial of 50%/25%. In addition, the comparison between RED-variance and RED-mean verifies that the variance var(\hat{r}_{*}) is a more discriminative metric than mean ĉ_{*}+\hat{r̅}_{*} in detecting OOD and adversarial samples.

The scalability of RED-variance was evaluated in a more complex OOD detection task: Images from the SVHN dataset were treated as OOD samples for VGG16 classifiers trained on CIFAR-10 dataset. The same RED and VGG16 models as discussed above were used without retraining. The cropped version (32-by-32 pixels) of SVHN dataset is used. In this example, 10,000 samples from SVHN test set are randomly selected to be added into the CIFAR-10 testing set, and RED and MCP are required to detect these SVHN samples using corresponding detection scores. Experimental results in Table 4 show that RED-variance consistently outperforms the MCP baseline.

TABLE 4

| AP-OOD (%) | AUPR-OOD (%) |
|---|---|
| RED-variance/MCP baseline | RED-variance/MCP baseline |
| 86.282 ± 2.212*/82.964 ± 1.850 | 86.276 ± 2.213*/82.958 ± 1.851 |

Thus, the empirical study described herein shows that RED provides a promising foundation not just for detecting misclassifications, but for distinguishing them from other error types as well. This is a new dimension in reliability and interpretability in machine learning systems. RED can therefore serve as a step to make deployments of such systems safer in the future.

In one interesting observation, RED almost never performs worse than the MCP baseline. This result suggests that there is almost no risk in applying RED on top of an existing NN classifier. Since RED is based on a GP model, the estimated residual \hat{r̅}_{*} is close to zero if the predicted sample is far from the distribution of the original training samples, resulting in no change to the original MCP. In other words, RED does not make random changes to original MCP if it is very uncertain about the predicted sample, and this uncertainty is explicitly represented in the variance of the estimated confidence score. This property makes RED a particularly reliable technique for error detection.

Another interesting observation is that the variance is also helpful in detecting OOD and adversarial samples. This result follows from the design of the RIO uncertainty model. Since RIO in RED has an input kernel and an output kernel, lower estimated variance requires that the predicted sample is close to training samples in both the input feature space and the classifier output space. This requirement is difficult for OOD and adversarial attacks to achieve, providing a basis for detecting them.

To conclude, present framework RED for error detection in neural network classifiers produce a more reliable confidence score than previous methods. RED is able to not only provide a calibrated confidence score, but also report the uncertainty of the estimated confidence score. Experimental results show that RED's scores consistently outperform state-of-the-art methods in separating the misclassified samples from correctly classified samples. Preliminary experiments also demonstrate that the approach scales up to large deep learning architectures, and can form a basis for detecting OOD and adversarial samples as well. It is therefore a promising foundation for improving robustness of neural network classifiers.

The foregoing description is a specific embodiment of the present disclosure. It should be appreciated that this embodiment is described for purpose of illustration only, and that those skilled in the art may practice numerous alterations and modifications without departing from the spirit and scope of the invention. It is intended that all such modifications and alterations be included insofar as they come within the scope of the invention as claimed or the equivalents thereof.

We claim:

1. A process for detecting errors in a base neural network classifier, the process comprising:
assigning a target detection score c to each training sample (χ,y) based on correctness of a classification prediction y for the training sample by the base neural network classifier;
predicting by a trained model with input-output (I/O) kernel, a residual r between the target detection score c and an original maximum class probability ĉ; and
for a given data point x_{*}, providing a Gaussian distribution of estimated residual \hat{r}_{*}, wherein \hat{r}_{*} is defined by residual mean \hat{r̅}_{*} and variance var(\hat{r}_{*}); and
adding \hat{r̅}_{*} and ĉ_{*} to calculate an error detection score ĉ′_{*}, wherein var(\hat{r}_{*}) indicates a corresponding uncertainty of the error detection score.

2. The process according to claim 1, wherein the input-output kernel utilizes raw features x and softmax outputs σ to predict the residual r.

3. The process according to claim 2, wherein the I/O kernel includes an input kernel kᵢₙ(xᵢ,xⱼ), which measures covariances in raw feature space, and a modified multi-output kernel kₒᵤₜ(σᵢ,σⱼ), which calculates covariances in softmax output space.

4. The process according to claim 3, wherein hyperparameters of the I/O kernel are optimized to maximize the log marginal likelihood log p(r|χ,σ).

5. The process according to claim 4, wherein the Gaussian distribution for the estimated residual \hat{r}_{*}˜ [symbol] (\hat{r̅}_{*}, var(\hat{r}_{*})).

6. The process according to claim 5, wherein the error detection score ĉ×′_{*} is calculated according to ĉ′_{*}˜ [symbol] (ĉ_{*}+\hat{r̅}_{*}, var(\hat{r}_{*})).

7. At least one computer-readable medium storing instructions that, when executed by a computer, perform a process for detecting errors in a base neural network classifier, the process comprising:
assigning a target detection score c to each training sample (χ,y) based on correctness of a classification prediction ŷ for the training sample by the base neural network classifier;
predicting by a trained model with input-output (I/O) kernel, a residual r between the target detection score c and an original maximum class probability ĉ; and
for a given data point x_{*}, providing a Gaussian distribution of estimated residual \hat{r}_{*}, wherein \hat{r}_{*} is defined by residual mean \hat{r̅}_{*} and variance var(\hat{r}_{*}); and
adding \hat{r̅}_{*} and ĉ_{*} to calculate an error detection score ĉ′_{*}, wherein var(\hat{r}_{*}) indicates a corresponding uncertainty of the error detection score.

8. The at least one computer-readable medium according to claim 7, wherein the input-output kernel utilizes raw features x and softmax outputs σ to predict the residual r.

9. The at least one computer-readable medium according to claim 8, wherein the I/O kernel includes an input kernel kᵢₙ(xᵢ,xⱼ), which measures covariances in raw feature space, and a modified multi-output kernel kₒᵤₜ(σᵢ,σⱼ), which calculates covariances in softmax output space.

10. The at least one computer-readable medium according to claim 9, wherein hyperparameters of the I/O kernel are optimized to maximize the log marginal likelihood log p(r|χ,σ).

11. The at least one computer-readable medium according to claim 10, wherein the Gaussian distribution for the estimated residual \hat{r}_{*}˜ [symbol] (\hat{r̅}_{*}, var(\hat{r}_{*})).

12. The at least one computer-readable medium according to claim 11, wherein the error detection score ĉ′_{*} is calculated according to ĉ′_{*}˜ [symbol] (ĉ_{*}+\hat{r̅}_{*}, var(\hat{r}_{*})).

13. A dual model system for detecting errors in a base neural network classifier, the system comprising:
a first model pre-trained as a base neural network classifier running on at least a first processor, wherein each training sample (χ,y) of the first model is assigned a target detection score c in accordance with correctness of the first model's classification prediction ŷ for the training sample; and
a second trained model including input-output (I/O) kernel for predicting a residual r between the target detection score c and an original maximum class probability ĉ;
wherein for a given data point x_{*}, the system provides a Gaussian distribution of estimated residual \hat{r}_{*}, wherein \hat{r}_{*} is defined by residual mean \hat{r̅}_{*} and variance var(\hat{r}_{*}), and calculates an error detection score ĉ′_{*} by adding \hat{r̅}_{*} and ĉ_{*}, and further wherein var(\hat{r}_{*}) indicates a corresponding uncertainty of the error detection score.

14. The system according to claim 13, wherein the input-output kernel utilizes raw features x and softmax outputs σ to predict the residual r.

15. The system according to claim 14, wherein the I/O kernel includes an input kernel kᵢₙ(xᵢ,xⱼ), which measures covariances in raw feature space, and a modified multi-output kernel kₒᵤₜ(σᵢ,σⱼ), which calculates covariances in softmax output space.

16. The system according to claim 15, wherein hyperparameters of the I/O kernel are optimized to maximize the log marginal likelihood log p(r|χ,σ).

17. The system according to claim 16, wherein the Gaussian distribution for the estimated residual \hat{r}_{*}˜ [symbol] (\hat{r̅}_{*}, var(\hat{r}_{*})).

18. The system according to claim 17, wherein the error detection score ĉ′_{*} is calculated according to ĉ′_{*}˜ [symbol] (ĉ_{*}+\hat{r̅}_{*}, var(\hat{r}_{*})).
